(19) United States
(12) Patent Application Publication
(10) Pub. No.: US 2009/0212459 A1
(43) Pub. Date: Aug. 27, 2009

(54) Method and System for Post-Treating Preforms

(75) Inventors: Witold Neter, Newnan, GA (US); Helmut Thoemmes, Kastel (DE); Rainer Petry, Klein-Winternheim (DE); Christian Wagner, Mainz (DE)

Correspondence Address: MICHAEL L. DUNN, SIMPSON & SIMPSON, PLLC, 5555 MAIN STREET, WILLIAMSVILLE, NY, 14221, US

(73) Assignee: MHT Mold & Hotrunner Technology AG, Hochheim (DE)

(21) Appl. No.: 12/085,793

(22) PCT Filed: Nov. 10, 2006
(86) PCT No.: PCT/EP2006/068363

§ 371 Date: Mar. 12, 2009

(30) Foreign Application Priority Data
Nov. 30, 2005 (DE) 10 2005 057 466.1
Jun. 20, 2006 (DE) 10 2006 028 725.8

(51) Int. Cl. B29C 71/02; B29C 45/72

(52) U.S. Cl. 264/237; 425/404; 264/232

(57) ABSTRACT

The invention concerns a system for the post-treatment of preforms (7) produced in an injection molding mold, comprising at least two post-treatment tools which each have a receiving plate (4) which has a group of receiving cavities (2) and a pin plate (6) which has a group of post-treatment pins (3), and a device for transferring the preforms (7) from the injection molding mold alternately into the at least two post-treatment tools. In order to provide a method of and a system for the post-treatment of preforms produced in an injection molding mold, which on the one hand allows early removal of the preform from the injection molding tool and which on the other hand allows reliable post-treatment in particular of the interior of the preform after removal from the injection molding mold, it is proposed in accordance with the invention that the post-treatment pins (3) remain in the preforms for a period of time which is longer than the mold stand time.

### BACKGROUND OF THE INVENTION

The present invention concerns a method of the post-treatment of blanks, e.g. preforms produced in an injection molding mold and a system therefor.

Injection molding is one of the most important methods of producing blanks or moldings. In that procedure the molding material which is generally originally in the form of powder or granular material is heated, plasticized and pressed under a high pressure into a suitable molding tool. The molding material hardens in the molding tool and is then removed from the opened tool.

Commercially available PET bottles are generally produced by expansion blow molding of a hollow body preform or hollow body parison. In that case the hollow body preform is produced in a first step by injection molding. The expansion blow molding operation which follows the injection molding operation can be effected either immediately after production of the hollow body preform or at a later moment in time.

A high level of complication and expenditure is necessary in production of the corresponding injection molding molds as the injection molding mold on the one hand must be designed for very high pressures and on the other hand it must also have suitably heated and/or cooled passages.

Usually an injection molding tool for the production of PET preforms comprises a large number of, for example 96, cavities, into which tool cores of a suitable configuration are introduced. When the tool is closed, that is to say when the core is inserted into the corresponding cavity, a space, referred to as the mold cavity or mold space, is formed between the core on the one hand and the cavity on the other hand. The plasticized plastic material, for example PET, is then injected under high pressure into that space. As soon as the PET preform has sufficiently cooled the mold can be opened and the preform removed.

The cycle time, that is to say the duration of the period of time between the beginning of the injection molding operation for a preform and the beginning of the injection molding operation for a subsequent preform is generally somewhat longer than the mold stand time. The cycle time is composed of the closing time, that is to say the time that the injection molding mold requires to close, the mold stand time, the opening time, that is to say the time that the injection molding mold requires to open, and a pause time. The pause time is generally determined by the time required to remove the preform from the opened mold. The mold stand time is the duration of the period of time between closing and opening of the tool. In other words the mold stand time is the time during which the tool is not moved in the closed condition.

To reduce the cycle times, that is to say the time from one injection operation to the next, it is already usual for the preform to be removed from the mold at a very early moment in time at which the preform is already solid at its outside surfaces but the internal region thereof, referred to as the preform core, is still fluid. In that condition the preform is generally transferred into what is referred to as a receiving plate which comprises a group of receiving cavities. Thus for example in what are referred to as vertical tools, that is to say those injection molding tools which are opened by a vertical movement of the one tool portion relative to the other, it is usual for the mold tool to be already opened after for example 10 seconds, for a receiving plate with corresponding receiving cavities to be moved into the mold, for the individual preforms to be allowed to drop into the receiving cavities by means of the force of gravity, for the receiving plate with the preforms to be moved out of the tool, for the mold to be closed again and for the next injection molding operation to begin. During the next injection molding operation the previous preforms remain in the receiving cavity which is usually cooled.

Embodiments are also known in which the individual preforms are removed from the mold by means of a gripper unit and transferred into the receiving plate arranged outside the tool mold.

As the preform must remain in the receiving cavity of the state of the art for a comparatively long time for the cooling operation, so that generally the next preform can already be removed from the injection molding tool before the preform in the receiving cavity has cooled down to such an extent that it can be removed without the risk of damage, it is already usual practice to employ receiving plates having a plurality of groups of receiving cavities, wherein each group has as many receiving cavities as the injection molding tool provides preforms per injection cycle. The individual receiving cavity groups are then successively filled with preforms so that the individual preform can remain in the receiving cavity for longer than an injection molding cycle.

Such receiving plates however are correspondingly large and can only be controlled with a very great deal of complication and expenditure.

In order further to reduce the cycle time quite a number of endeavours have been made in recent years to already remove the preform from the injection molding mold at an early moment in time. As the preform is still relatively soft at such an early moment in time high demands are made on the post-treatment procedure. Thus occasional proposes have already been set forth for occasionally cooling or post-treating the preform held in a receiving cavity, with a post-treatment pin which is introduced into the preform. In the known apparatuses with a post-treatment pin however it is only briefly engaged into the preform.

WO 03/097326 already discloses an apparatus for the post-treatment of preforms produced in an injection molding mold. That machine has a tool block with two different groups of tool cores. In addition the arrangement has four receiving plates arranged on a cube, as well as two pin plates. After the preforms have been produced in the injection molding machine, the latter is opened and the tool block turned in such a way that the other group of tool cores can co-operate with the tool cavities. The preforms produced by means of injection molding are now on the free tool cores. From there they are now transferred into a receiving plate with corresponding receiving cavities. The receiving cube with the individual receiving plates is then turned through 90° and a pin plate is briefly moved into the preforms. Thereafter the pin plate is moved out again and the receiving cube turned through a further 90° and another pin plate is again introduced into the preforms.

The frequent inward and outward movement of the post-treatment pins however does not guarantee reliable post-treatment of the interior of the preforms.

Taking that state of the art as the basic starting point therefore the object of the present invention is to provide a method of and a system for the post-treatment of preforms produced in an injection molding mold, which on the one hand allows early removal of the preform from the injection molding tool and on the other hand allows reliable post-treatment in particular of the interior of the preform after removal from the injection molding mold.

### BRIEF SUMMARY OF THE INVENTION

In regard to the method the specified object is attained in that the preform is transferred out of the injection molding mold into a receiving cavity whose internal shape substantially corresponds to the external shape of the preform, and a post-treatment pin whose external shape substantially corresponds to the internal shape of the preform is introduced into the preform and remains there for a period of time which is longer than the cycle time of the injection molding mold. It is essential therefore that post-treatment of the preform is effected in a receiving cavity into which a corresponding post-treatment pin has been introduced, wherein the pin remains in the preform for some time which is markedly longer than the mold stand time of the injection molding machine.

More specifically, in accordance with the invention, a system is provided for the post-treatment of preforms (7) produced in an injection molding mold. The system includes at least two post-treatment tools each of which have its own receiving plate (4) which has a group of receiving cavities (2) and its own pin plate (6) which has a group of post-treatment pins (3), and

a device for transferring the preforms (7) out of the injection molding mold alternately into the at least two post-treatment tools,

wherein the pin plate (6) and the receiving plate (4) of each post-treatment tool are reciprocatingly movable relative to each other between an open position in which the post-treatment pins (3) are arranged outside the receiving cavities (2) and a post-treatment position in which the post-treatment pins (3) are arranged at least partially in the receiving cavities (2).

The receiving cavity can have either an open and a closed end or two open ends. The configuration with an open and a closed end has the advantage that the receiving cavity also follows the external shape of the preform in the bottom region thereof.

The embodiment with two open ends makes it possible to produce specifically adapted cooling fluid flows within the receiving cavity.

In tests it has been found that the post-treatment pin remains in the preform if possible at least for double the mold stand time, preferably at least three times the mold stand time and particularly preferably at least four times the mold stand time.

### BRIEF DESCRIPTION OF THE SEVERAL VIEWS OF THE DRAWING

FIG. 1 shows a diagrammatic view of a first embodiment of the system according to the invention,

FIG. 2 shows a diagrammatic view of a second embodiment of the system according to the invention,

FIGS. 3 through 9 show various processing steps of a third embodiment of the system according to the invention,

FIGS. 10 through 18 show a plurality of steps of a fourth embodiment of the system according to the invention,

FIGS. 19 through 22 show a plurality of working steps of a fifth embodiment,

FIGS. 23 through 31 show a plurality of working steps of a sixth embodiment,

FIGS. 32 through 34 show a plurality of working steps of a seventh embodiment,

FIG. 35 shows a cross-sectional view of a post-treatment pin of the seventh embodiment,

FIG. 36 shows a sectional view through a receiving cavity and a bottom post-treatment device of the seventh embodiment,

FIG. 37 shows a side view and a side from above of the swirl element of the seventh embodiment and a diagrammatic representation of the flow of cooling fluid, and

FIG. 38 shows a sectional view through a part of a post-treatment tool with diagrammatically illustrated flow of cooling fluid.

### DETAILED DESCRIPTION OF THE INVENTION

In injection molding procedures, frequently all operating movements are adapted to the cycle time. Therefore an alternative configuration of the method provides that the post-treatment pin remains in the preform at least for double the cycle time, preferably at least three times the cycle time and particularly preferably at least four times the cycle time.

Furthermore a particularly preferred embodiment provides that the preform is prevented from coming into contact with the internal surface of the receiving cavity by means of a fluid, preferably a gaseous fluid, which is introduced into the receiving cavity through an opening preferably in the proximity of a closed end of the receiving cavity. When the preform is transferred into the receiving cavity the preform is under some circumstances still soft so that any contact between the preform on the one hand and the internal surface of the receiving cavity on the other hand would result in irreversible deformation of or damage to the preform. Therefore the preform is advantageously held on an air cushion which prevents direct contact. A further particularly preferred embodiment provides that a fluid, preferably a gaseous fluid, is introduced into the preform at least at times through an opening in the post-treatment pin, wherein in a particularly preferred embodiment the fluid is introduced into the preform in such a way that the preform is further pressed into the receiving cavity by the fluid as it flows out and substantially without direct contact between the post-treatment pin and the preform.

There is thus a condition in which the preform touches substantially neither the receiving cavity nor the post-treatment pin, but is only held on the air cushions which are provided by the receiving cavity on the one hand and the post-treatment pin on the other hand. For definitive shaping of the preform the post-treatment pin can then be still further introduced into the receiving cavity so that, if the supply of fluid through the receiving cavity is shut down for a brief moment, the external wall of the preform is pressed against the internal wall of the receiving cavity. In the same way contact could also occur between the internal wall of the preform and the external surface of the post-treatment pin. Tests have shown however that the best results are achieved if contact occurs only at the receiving cavity but not at the post-treatment pin.

As an alternative thereto it is also possible for the post-treatment pin to be so dimensioned that the preform shrinks upon cooling on to the post-treatment pin. In that respect it is desirable if the outside diameter of the receiving finger is substantially equal to the inside diameter of the blank to be removed, in the cooled condition. In that way the receiving finger only slightly influences contraction of the material upon cooling and the blank can be removed from the receiving finger after cooling, with a comparatively low force.

It will be appreciated that it is also possible for the preform firstly to be transferred on to a post-treatment pin whose external shape substantially corresponds to the internal shape of the preform and to provide a receiving cavity which is movable relative to the post-treatment pin in such a way that it surrounds the post-treatment finger and the preform arranged thereon. In that respect it is desirable if the receiving cavity has an internal wall which approximately corresponds to the external shape of the preform.

A preferred embodiment uses a receiving cavity having two open ends. Cooling fluid is introduced into the receiving cavity in such a way that the fluid flows along the outside of the preform and issues from both ends of the receiving cavity. That makes it possible to provide for very specifically targeted cooling of the preform.

In regard to the system the foregoing object is attained by a system for the post-treatment of preforms produced in an injection molding mold, comprising at least two post-treatment tools which each have a receiving plate which has a group of receiving cavities and a pin plate which has a group of post-treatment pins, and a device for transferring the preforms out of the injection molding mold alternately into the at least two post-treatment tools, wherein the pin plate and the receiving plate of each post-treatment tool are reciprocatingly movable relative to each other between an open position in which the post-treatment pins are arranged outside the receiving cavities and a post-treatment position in which the post-treatment pins are arranged at least partially in the receiving cavities.

In contrast to the state of the art it is therefore not provided that a receiving plate co-operates successively with different pin plates, but each receiving plate has its own pin plate with which it exclusively co-operates. The at least two post-treatment tools are alternately occupied by preforms.

That ensures that the pin plate co-operates with the receiving plate over a period of time which is markedly longer than the cycle time of the injection molding tool, and that permits effective post-treatment of the preforms.

Furthermore a preferred embodiment provides that the transfer device is a gripper plate with gripper elements for gripping the preforms in the injection molding mold and transporting the preforms to the post-treatment tool. In other words, as soon as the injection molding mold is opened, the gripper plate moves thereinto and grips the preforms and transfers them from the injection molding mold alternately into the individual post-treatment tools.

As an alternative thereto the receiving plate of a post-treatment tool can also be moved into the opened tool mold, wherein there is provided an ejection system having ejection elements with which the preforms can be released from the injection molding mold and can be transferred into the receiving plate so that by virtue of the force of gravity they can be passed over.

In a further alternative embodiment in the open position of the post-treatment tool the pin plate or the receiving plate is reciprocatingly movable laterally between the open position in which the pins are in opposite relationship to the receiving cavities and a transfer position in which the pins and the receiving cavities are not in opposite relationship. In that movement the pin plate and the receiving plate remain substantially parallel to each other and do not alter their spacing. The movement occurs substantially exclusively in a lateral direction. If for example the receiving plate is laterally movable the movement takes place within the plane of the receiving plate. In other words, in a first step the post-treatment tool comprising the receiving plate and the associated pin plate can be moved into the opened position by for example the pin plate being moved relative to the receiving plate in a direction perpendicular to the plate planes. As soon as the post-treatment tool is in the opened position, for example the receiving plate can be moved beside the pin plate laterally, that is to say without the spacing between the pin plate and the receiving plate changing, so that the preforms can be received or the preforms can be removed.

Furthermore in a particularly preferred embodiment there is provided a robot unit with which each post-treatment tool can be moved into a readiness position in which the post-treatment tool can be moved into the open position and can be equipped with the preforms, and into a removal position in which the post-treatment tool can be moved into the opened position and the preforms can be removed.

In that respect for example the robot unit can be so designed that each post-treatment tool can be moved into a waiting position. In other words there are at least three locations or positions into which the individual post-treatment tools can be moved by the robot unit, the readiness position, the waiting position and the removal position. While the post-treatment tool is in the waiting position post-treatment of the preforms is effected within the tool.

By way of example the robot unit can be a rotational unit which is rotatable about an axis of rotation, wherein the receiving plates are fixed to the rotational unit so that they can be moved from the readiness position into the removal position by rotation of the rotational unit. In that respect in a preferred embodiment it is provided that in the removal position the corresponding post-treatment tool can be moved into the open position, wherein the receiving plate and the pin plate are movable in the open position relative to each other laterally into an ejection position in which the preforms can be ejected from the receiving plate. In a particularly preferred embodiment in the ejection position the open ends of the receiving cavities are so arranged that the preforms can be ejected from the receiving cavities because of their own weight.

The transfer position can be arranged either within the injection molding mold or outside it.

In a further particularly preferred embodiment the pin plate has through openings, through which the preforms can be introduced into and/or ejected from the receiving cavities. That has the advantage that, for receiving the preforms or for removal thereof, the receiving plate and the pin plate only have to be displaced a small distance laterally relative to each other as then the preforms are received or removed respectively by way of the through openings.

In an alternative embodiment it is provided that the pin plate has gripper elements, wherein a gripper element is associated with each receiving cavity or each pin respectively and the pin plate and the receiving plate are movable relative to each other laterally between two positions and are movable towards and away from each other in both positions so that in the one position the post-treatment pins can be introduced into the receiving cavities and removed again and in the other position the preforms can be removed from the receiving cavities by means of the gripper elements.

A further preferred embodiment has a positioning device for positioning the first post-treatment tool in at least one positioning direction, wherein the at least two post-treatment tools are connected together so that, with the positioning device for positioning the first post-treatment tool, at least one further post-treatment tool can be positioned by corresponding positioning of the first post-treatment tool.

That markedly simplifies the positioning mechanism. There is no need for a dedicated positioning mechanism to be associated with each post-treatment tool. Rather the positioning mechanism moves all post-treatment tools as a whole. As there is only ever one post-treatment tool that is fitted with a further set of preforms to be post-treated, the position of the other post-treatment tools in which previous groups of preforms are being post-treated is not of significance.

It is further advantageous if each post-treatment tool has an opening and closing device for moving the pin plate and the receiving plate between the open position and the post-treatment position.

In that respect a particularly preferred embodiment provides that the positioning device and the opening and closing device are oriented in mutually co-linear relationship.

Thus it is possible for example that the at least two post-treatment tools are arranged in mutually juxtaposed relationship in the positioning direction, wherein the receiving plate of a post-treatment tool is connected to the pin plate of another post-treatment tool. When now the opening and closing device of a post-treatment tool is actuated, that has the effect that the receiving plate and all further post-treatment tools mounted thereto is moved relative to the pin plate and all further post-treatment tools mounted thereto.

By way of example the positioning device can comprise a linear drive, preferably a servo motor. The at least two post-treatment tools can be arranged displaceably on rails.

In a preferred embodiment the opening and closing device is a stroke device. By way of example a pneumatic cylinder or an electric drive can be used here.

As an alternative thereto it is also possible to provide only one opening and closing device. In that case it is advantageous if the opening direction of all post-treatment tools is oriented in the positioning direction, all post-treatment tools are arranged in a row in mutually juxtaposed relationship in the positioning direction, the positioning device is connected to the first post-treatment tool of the row and the opening and closing device is connected to the last post-treatment tool of the row. In addition it is desirable if all post-treatment tools have a locking device which in the locked position prevents opening of the post-treatment tool. According to which respective post-treatment tool is to be opened, the locking device in question can then be released. When now the opening and closing device is actuated it ‘pulls’ at the one end of the row of post-treatment tools while the positioning device ‘retains’ the other end of the row. Consequently the post-treatment tool which is not unlocked will open. It is therefore possible to position and open a plurality of post-treatment tools with only one positioning device and only one opening and closing device.

Furthermore there can be provided a guide element for guiding the blank out of the post-treatment tool which when the post-treatment tool is opened can be moved between the receiving plate and the pin plate of the post-treatment tool. The guide element ensures that the preforms are guided upon ejection out of the post-treatment tool.

In that respect the guide element can be a substantially U-shaped rail. Possibly discharge of the preforms can also be expedited by the provision of a compressed air source or a vacuum source.

In a particularly preferred embodiment the guide element is provided on the device for transferring the preforms from the injection molding mold into the post-treatment tools.

In a further preferred embodiment at least one receiving plate is at the same time in the form of a pin plate. In other words that plate has both a group of receiving cavities and also a group of post-treatment pins. In that respect the group of receiving cavities belongs to a different post-treatment tool, from the group of post-treatment pins. By virtue of such a design configuration it is possible to save on material and thus weight in the production of the post-treatment tools.

Advantageously the post-treatment tools are arranged in succession in the opening direction, wherein preferably the post-treatment pins and the receiving cavities of two adjacently arranged post-treatment tools are displaced relative to each other by approximately half the spacing of two adjacent receiving cavities of a receiving plate. For the situation where there is provided a plate which has both receiving cavities and also post-treatment pins, this means that a post-treatment pin is arranged approximately in the middle between two receiving cavities.

Furthermore a particularly preferred embodiment provides that the at least two post-treatment tools each additionally have a bottom plate with a group of bottom post-treatment devices, wherein the receiving cavities are open on both sides. When a preform is introduced into such a receiving cavity, the bottom of the preform is freely accessible by virtue of the open end of the bottom. In order to ensure effective post-treatment also of the bottom of the preform, there is therefore provided a bottom post-treatment device. That can comprise for example a nozzle with which cooling fluid can be directed on to the bottom of the preform.

A particularly preferred embodiment is one in which at least one plate is at the same time the bottom plate of a first post-treatment tool, the receiving plate of a second post-treatment tool and the pin plate of a third post-treatment tool. That multifunction means that it is possible to save on material for the production of post-treatment tools.

Another particularly preferred embodiment provides that the receiving plate has a feed means for a cooling fluid, wherein the feed means for cooling fluid is so arranged that cooling fluid can be passed into each receiving cavity.

In that respect in a desirable embodiment it is provided that the receiving cavities have two open sides and the feed means for cooling fluid is so arranged that the cooling fluid is divided and leaves the receiving cavity at both open sides. The flow of cooling fluid is thus divided and serves for cooling different portions of the preform. By virtue of a suitable choice of the flow cross-sections, that is to say the spacing between the receiving cavity on the one hand and the preform on the other hand, it is possible to set the amount of cooling fluid which is provided for the post-treatment of various portions of the preform. Thus each portion of the preform can be cooled or post-treated in a specifically targeted fashion by that measure according to the invention.

In that respect in a particularly preferred embodiment the feed means for cooling fluid has a swirl element which is so designed that it imparts a circular rotational movement to the cooling fluid. The consequence of this is that the cooling fluid not only flows past the preform in the longitudinal direction thereof but also flows around the preform in a helical path.

The swirl element for example can be a sleeve with a plurality of slots arranged in the longitudinal direction, wherein the slots are inclined relative to the radial direction in a sectional view perpendicularly to the sleeve axis.

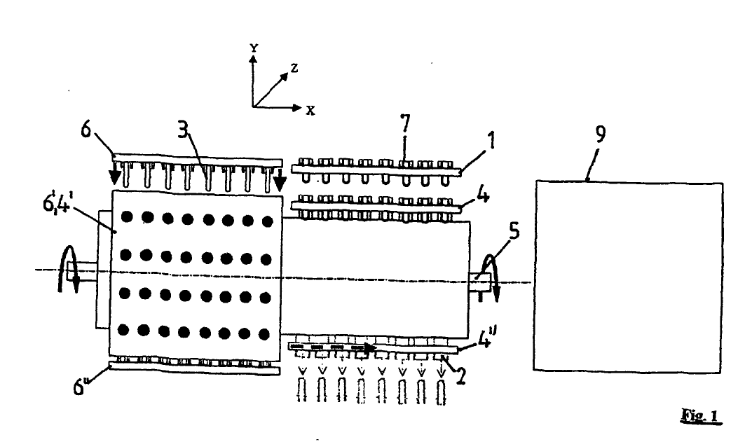

Further advantages, features and possible uses of the present invention will be clearly apparent from the description hereinafter of preferred embodiments and the accompanying Figures FIG. 1 shows a first embodiment of a system according to the invention for the post-treatment of preforms 7 produced in an injection molding mold 9. The mold 9 is only diagrammatically shown here.

The post-treatment system according to the invention here comprises four post-treatment tools which each comprise a receiving plate 4, 4′, 4″, 4′″ and a pin plate 6, 6′, 6″, 6′″. The four treatment tools are fixed to a rotatable shaft 5 so that the four post-treatment tools can be moved into four different positions by stepwise rotation of the shaft 5 through 90°.

The position shown at the top in FIG. 1 is what is referred to as the readiness position. Here the post-treatment tool is ready to receive the preforms 7 produced by the injection molding mold 9. For receiving the preforms, firstly the post-treatment tool is moved into the open position, that is to say the pin plate 6 is moved with its post-treatment pins 3 out of the corresponding receiving cavities 2 of the receiving plate 4. That opening movement takes place substantially perpendicularly to the plate plane. Then the receiving plate 4 can be moved with the individual receiving cavities 2 laterally, that is to say parallel to the plate plane in the direction of the injection molding mold 9. In that position a gripper plate 1 can now move into the opened injection molding mold 9, to grip the preforms 7 which are hardened at their outside, to move them out of the injection molding mold 9 and to transfer them into the receiving plate 4 which is standing ready.

The receiving plate 4 now moves with the received preforms towards the left again so that the preforms or the receiving cavities 2 are arranged exactly opposite the post-treatment pins 3 of the pin plate 9. The pin plate 9 can now be moved perpendicularly to the plate plane into the receiving cavities again. The actual post-treatment of the preforms is effected in that condition. While now the next group of preforms is being produced in the injection molding mold 9, the robot unit will rotate the shaft 5 so that another one of the four post-treatment tools comprising the pin plate 6 and the receiving plate 4 assumes the position shown at the top in FIG. 1.

Here too the pin plate is moved out of the mold into the open position, and the receiving plate is again moved towards the right into the transfer position so that it is ready to receive the next group of preforms while the previous group of preforms still remains in the corresponding post-treatment tool. After repeated transfer of the next group of preforms and movement of the corresponding pin plate into the receiving plate 4 and further rotation of the shaft 5, the receiving tool with the first group of preforms 7 adopts at some time the position shown at the bottom in FIG. 1. The individual receiving cavities 2 are now so arranged that their open end faces downwardly. In that position the pin plate 6″ can be moved out of the receiving plate 4″, the receiving plate 4″ can be displaced towards the right laterally with respect to the pin plate 6″, in which case the preforms 7 are still in the receiving cavities of the receiving plate 4″ and are held fast in the cavities possibly by means of suitable holding devices or for example by means of vacuum until the receiving plate 4″ has reached the position shown in broken line in FIG. 1. The holding device is then released or, instead of vacuum, compressed air is now applied to the receiving cavities so that the preforms 7, by virtue of their own weight, can drop out of the receiving plate 4″.

The rotation of the shaft does not always have to be through 90°. Rather, the rotation can also be through a multiple of 90°, more specifically preferably in such a way that, after the shaft has rotated three times, the receiving tool which is next arranged in the readiness position is disposed in the removal position.

It will be appreciated that the withdrawal movement of the receiving plate can take place in a lateral direction synchronously with the lateral withdrawal movement of that receiving plate which is just in the readiness position so that one and the same drive can be used for that.

It will be clear that, in the embodiment according to the invention, just one pin plate is associated with each receiving plate, the post-treatment pins of which pin plate remain within the receiving cavities of the receiving plate throughout the entire post-treatment process.

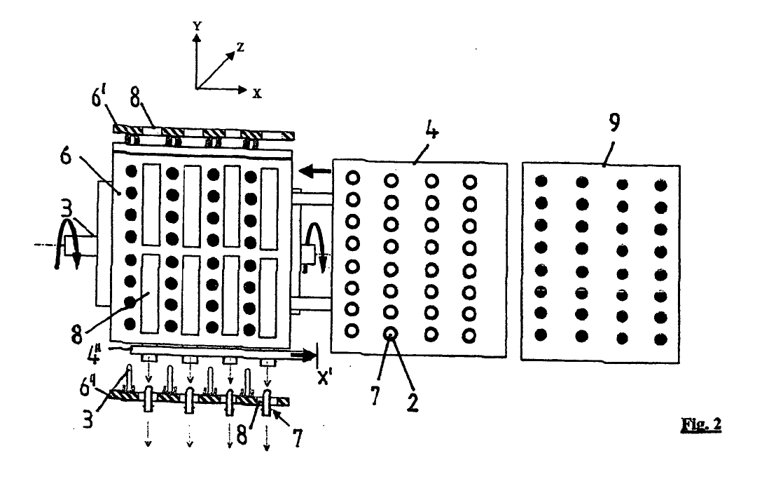

FIG. 2 shows a second embodiment of the post-treatment system according to the invention. Here too the injection molding mold 9 is only diagrammatically shown. As in the first embodiment here there are a total of four post-treatment tools comprising pin plates 6, 6′, 6″, 6′″ and receiving plates 2, 2′, 2″, 2′″. Once again the four post-treatment tools are fixed to a rotatable shaft 3 driven by means of a robot unit. Unlike the embodiment of FIG. 1 here the injection molding mold 9 is a horizontal tool, that is to say the two halves of the injection molding mold open in a horizontal direction which in FIG. 2 is identified as the Z-direction (for clarification purposes a co-ordinate cross is shown in the Figure) so that a part of the mold 9 moves towards or away from the person viewing the Figure while the other part of the mold 9 does not move. The receiving plate 4 which in FIG. 2 is oriented in the direction of the viewing person, with the receiving cavities 2, can be moved into the gap formed by the opening process of the injection molding mold between the mold cores and the corresponding cavities. For that purpose firstly the corresponding pin plate 6 is moved perpendicularly to the plate plane into the opened position so that the post-treatment pins 3 pass completely out of the receiving cavities 2 of the receiving plate 4. Lateral movement of the receiving plate 4 is then effected in the X-direction into the opened injection molding mold 9.

As soon as the receiving plate 4 is within the injection molding mold 9 the preforms 7 which are already hardened at the outside are transferred into the receiving cavities 2 of the receiving plate 4. Then the receiving plate 4 is moved in the X-direction again, this time towards the left. The individual preforms 7 are now contained in the receiving cavities 2. As soon as the receiving cavities 2 are again arranged opposite the post-treatment pins 3 of the associated pin plate 6 the pin plate 6 is moved in the direction of the receiving plate 4 so that the post-treatment tool is closed. There now occurs a rotation of the shaft 3 through 90° so that the next post-treatment tool comprising the pin plate 6 and the receiving plate 4 assumes the corresponding readiness position to accept the next group of preforms with the injection molding tool 9 open. In the meantime post-treatment of the previous group of preforms takes place. As soon as the shaft 3 has now been rotated a total of three times through 90° the first post-treatment tool has reached the position shown at the bottom in FIG. 2. It will be seen here that, unlike the embodiment of FIG. 1, the pin plate 6″ has a plurality of through openings 8 arranged substantially beside the post-treatment pins 3. For removal of the preforms 6 the pin plate and/or the receiving plate 4 do not have to be completely moved out but only a short distance, as shown at the bottom in FIG. 2. Here the receiving plate 4 is moved in the X-direction only as far as the point X′ so that the preforms 7 can be ejected through the through openings 8 of the pin plate 6.

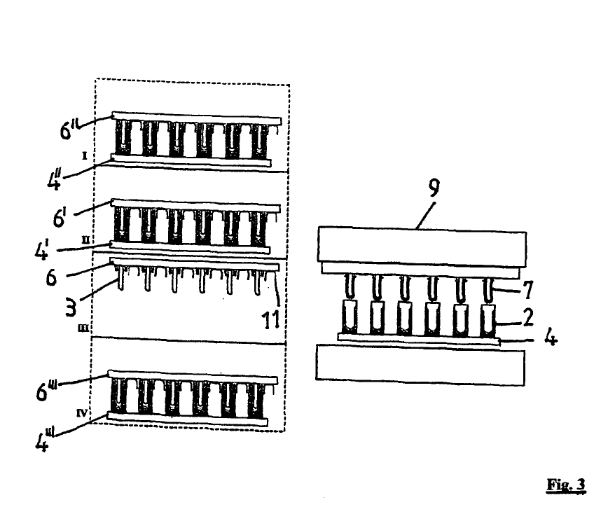

FIG. 3 shows a third embodiment of the post-treatment system according to the invention. Here too the post-treatment system has a total of four post-treatment tools I, II, III, IV each comprising a pin plate 4 and a receiving plate 2. Here the four post-treatment tools are arranged shelf-like one above the other and a robot unit (not shown) can move the entire structure comprising all four post-treatment tools upwardly or downwardly so that the desired post-treatment tool can be moved into the corresponding readiness position. In the condition shown in FIG. 3 the second lowest post-treatment tool III is in the readiness position. In that position the corresponding pin plate 6 with the individual post-treatment pins 3 is moved upwardly so that the post-treatment pins 3 pass out of the receiving cavities 2 of the receiving plate 4. The receiving plate 4 can then be moved in the X-direction, that is to say towards the right in FIG. 3 into the opened mold 9. Here the mold 9 is once again what is referred to as a vertical system, that is to say the movable tool half moves in a vertical direction to open the mold. The tool mold 9 has a plurality of cores 12, on which are held the preforms 7 which are already hardened at their outside. As soon as the receiving plate 4 is in the FIG. 3 position, the preforms 7 are ejected from the cores of the mold 9 so that they land in the receiving cavities 2 of the receiving plate 4. It should be noted at this juncture that the system shown in FIGS. 3 through 9 can also be used for a horizontal tool in which the injection molding mold opens in a horizontal direction. Then the receiving tools would have to be arranged not one above the other but one beside the other. If FIGS. 3 through 9 are viewed as views from above, they clearly show the arrangement for a horizontal tool.

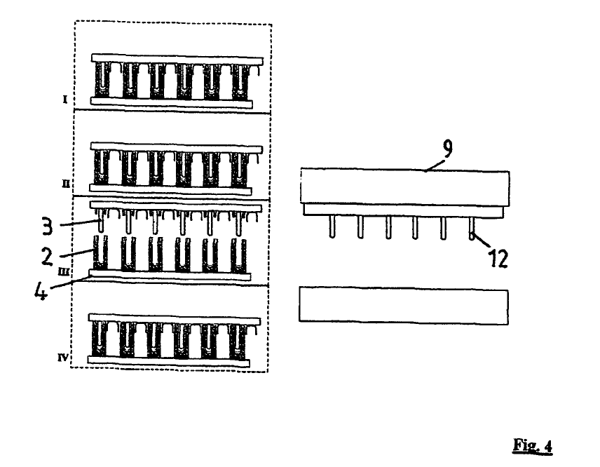

Then, as shown in FIG. 4, the receiving plate 4 is moved to its position in opposite relationship to the corresponding pin plate 6 again. The post-treatment tool is now closed by the post-treatment pins 3 being introduced into the receiving cavities 2 again.

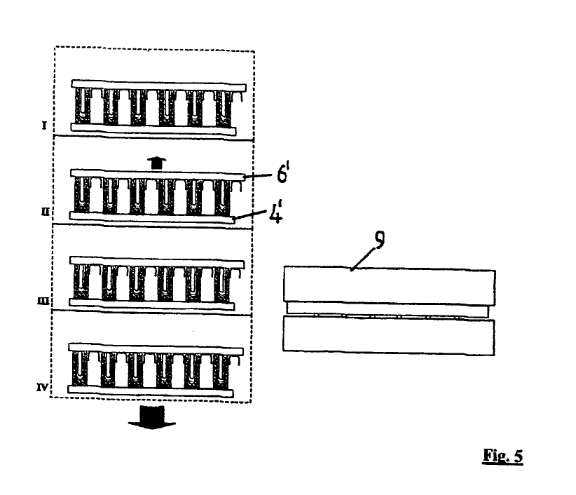

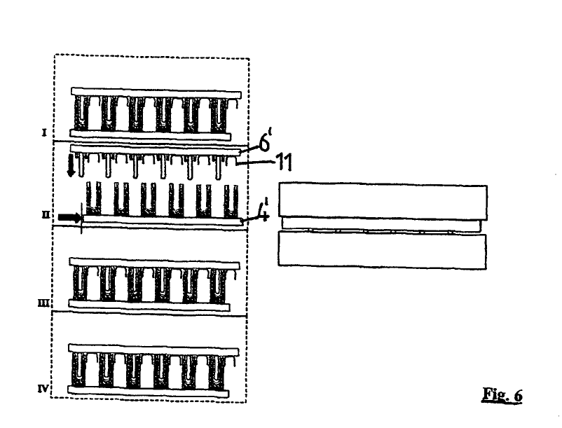

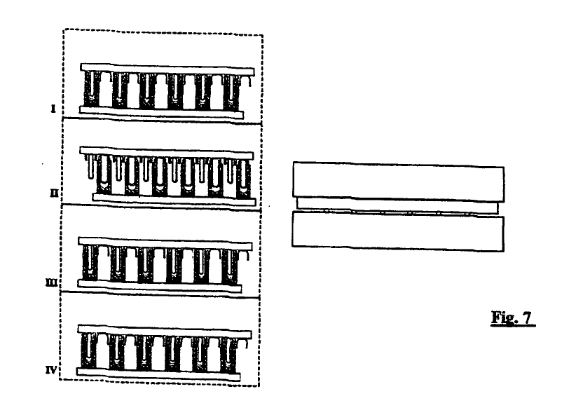

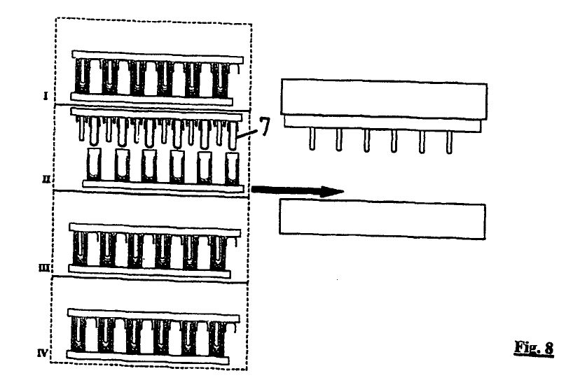

In the next step shown in FIG. 5 the mold 9 is closed to produce a next group of preforms. Now corresponding preforms are disposed in the post-treatment system in all four post-treatment tools. The entire post-treatment system is moved downwardly by means of the robot unit (indicated by the large arrow) so that the second uppermost post-treatment tool II moves into the readiness position. At the same time the corresponding post-treatment system opens, as indicated by the small arrow, so that the corresponding pin plate 6′ is moved out of the receiving plate 4′. That condition is shown in FIG. 6. Next the corresponding receiving plate 4′ is moved a distance towards the right, as also already shown in FIG. 6. It will be clearly seen that the pin plate 6′ of this embodiment has corresponding gripper elements 11 arranged beside the post-treatment pins 3. The receiving plate 4′ is displaced in the X-direction, that is to say parallel to the plate plane, to such an extent that the receiving cavities or the preforms 7 held therein come to lie in opposite relationship to the corresponding gripper elements 11. Now the pin plate 6′ is moved in the direction of the receiving plate 4′ again so that, as shown in FIG. 7, the gripper elements 11 come into engagement with the preforms 7 and hold them fast. In the next step the pin plate 6′ is then moved out of the receiving plate 4′ again. At the same time the mold 9 opens, as shown in FIG. 8. The preforms 7 are now held by the gripper elements 11 of the pin plate 6′ so that the receiving plate 4′ again has free receiving cavities 2. The receiving plate 4′ is now moved towards the right again, as illustrated by the arrow in FIG. 8. The gripper elements can for example grip the preforms by means of vacuum. Thus the gripper elements could be in the form of caps which are moved to the opening of the preforms and are acted upon with vacuum to grip the preforms. As an alternative thereto the post-treatment pins could also be in the form of gripper elements so that they are connected to a vacuum source for removal of the preforms.

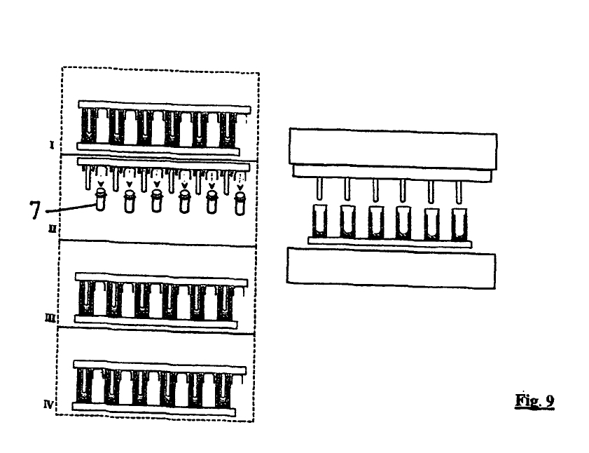

In FIG. 9 transfer of the next preforms on to the receiving plate 4′ is already taking place, during which the gripper elements 11 allow the preforms 7 to drop by virtue of the force of gravity acting thereon so that they can be fed to further processing procedures.

The described method is now repeated successively for all four post-treatment tools. It will be appreciated that, although hitherto embodiments with four post-treatment tools have been respectively described, embodiments with a different number of post-treatment tools can also be used. The only essential aspect is that at least two post-treatment tools are provided so that the preforms 7 can remain therein over a longer period of time which is markedly greater than the cycle time in the injection molding mold 9.

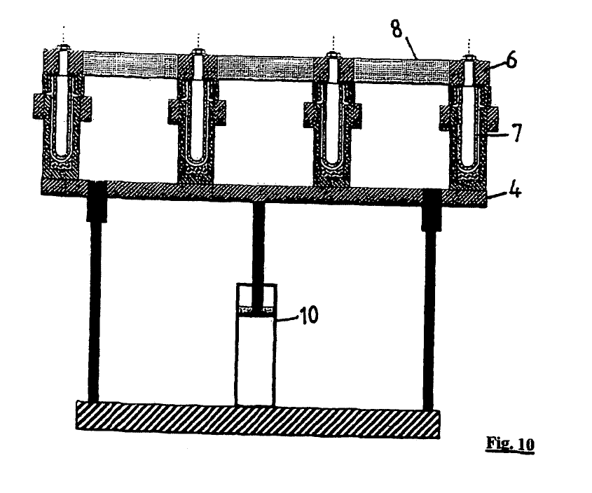

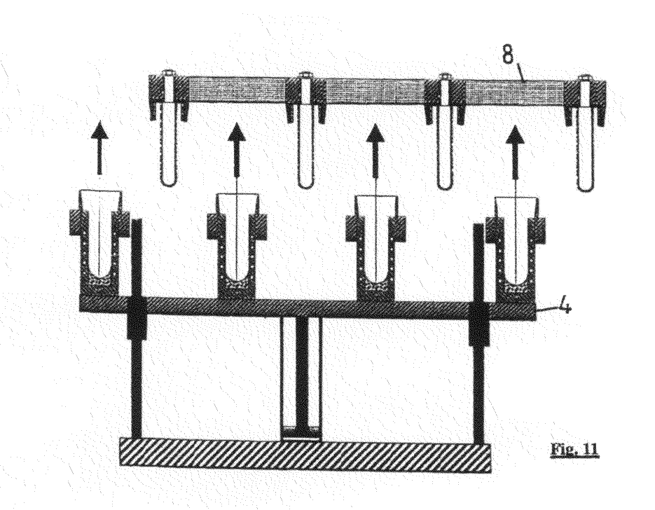

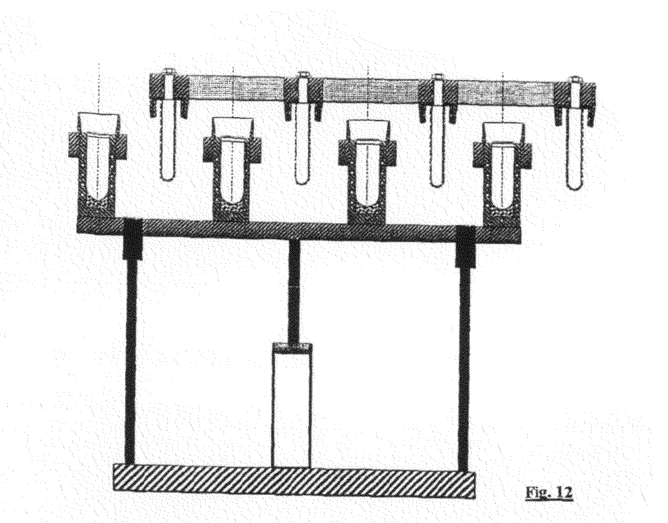

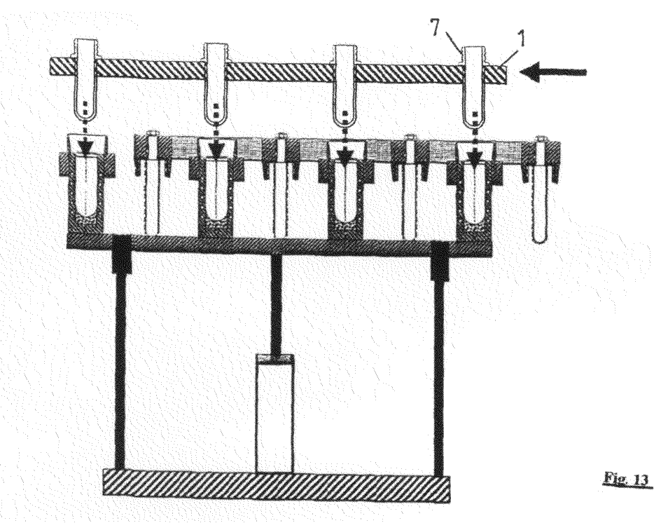

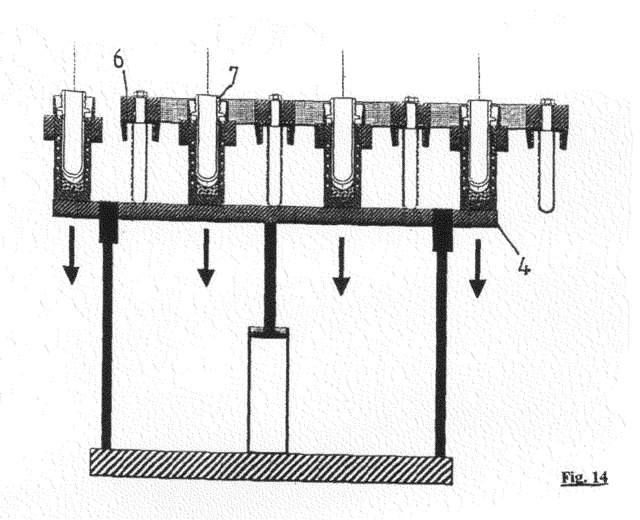

FIG. 10 shows a further embodiment of a post-treatment system according to the invention. Here too the receiving tool comprises a receiving plate 4 and a pin plate 6. The receiving plate 4 can here be moved towards and away from the pin plate 6 by means of a drive 10. The sequence of movements of the individual plates in this embodiment are described in the following Figures. Firstly the post-treatment tool is opened by the receiving plate 4 being moved downwardly, that is to say away from the pin plate 6, so that the individual pins 3 no longer engage into the receiving cavities 2. The pin plate 6 which has openings 9 is then moved somewhat towards the right, more specifically by about half the spacing between the individual post-treatment pins 3. That condition is shown in FIG. 11. The receiving plate 4 is now moved in the direction of the pin plate 6 again. That position is shown in FIG. 12. FIG. 13 now shows a gripper unit 1 which holds the individual preforms 7. The preforms are positioned above the receiving cavities 2 of the receiving plate 4 by means of the gripper unit 1. The gripper unit 1 releases the preforms 7 so that they can drop into the receiving cavities 2 as indicated by the broken-line arrows. That condition is shown in FIG. 14. It will be seen in this embodiment that the individual preforms 7 do not engage completely into the receiving cavities 2. That is because the receiving cavities 2 have a porous insert 11 through which a fluid, for example compressed air, is supplied. An air cushion is thus formed between the preform 7 on the one hand and the receiving cavity 2 on the other hand so that the preform 7 is not in contact with the receiving cavity 2. Now the receiving plate 4 is moved away from the pin plate 6 again, as indicated by the arrows in FIG. 14.

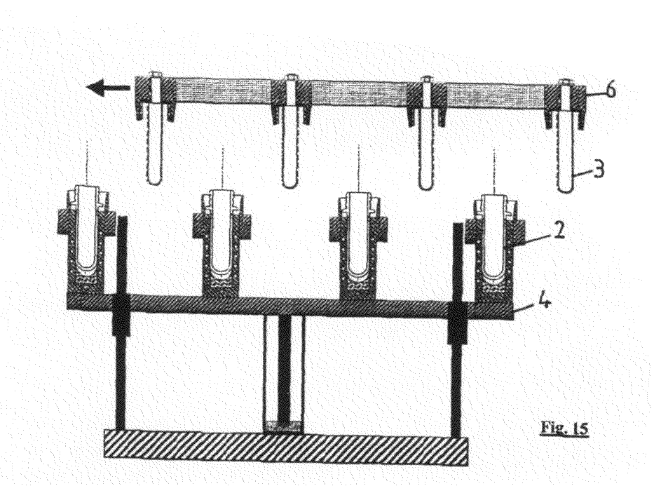

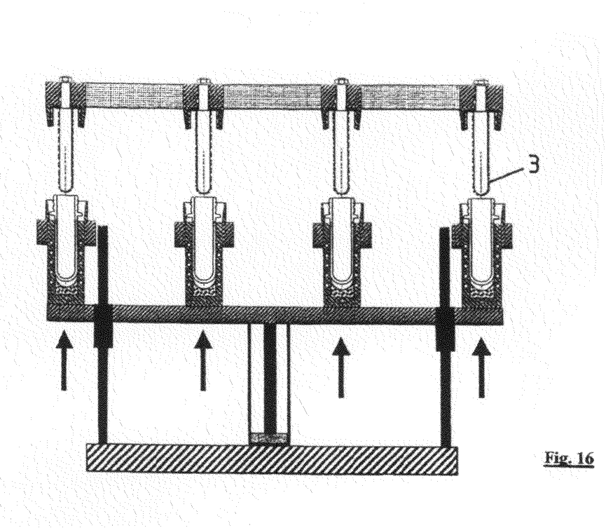

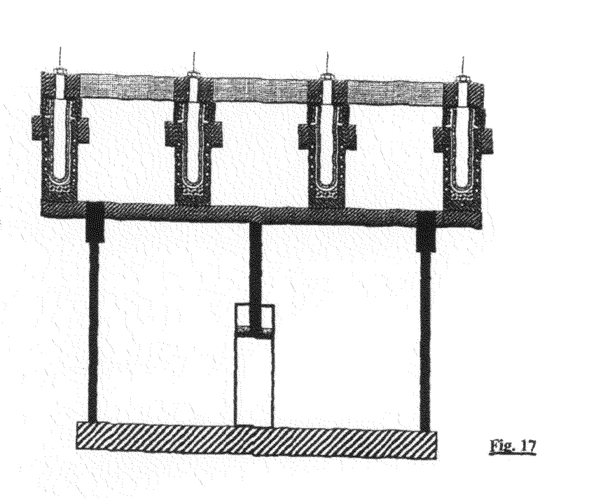

That condition is shown in FIG. 15. The pin plate 6 is now moved towards the left again until the individual post-treatment pins 3 again come to lie directly above the receiving cavity 3 or the preform 7 disposed therein. That condition is shown in FIG. 16. As can be seen here, in this embodiment the post-treatment pins 3 are made from a porous material. Compressed air is supplied through the porous material so that when, as already indicated by the arrows in FIG. 16, the receiving plate 4 is moved in the direction of the pin plate 6 again, the preforms 7 are pressed in substantially contact-free relationship completely into the receiving cavity 2 by virtue of the air cushion formed between the post-treatment pin 3 and the preform. That condition is shown in FIG. 17. The post-treatment tool remains in that condition for a relatively long time which is markedly longer than the cycle time of the injection molding tool.

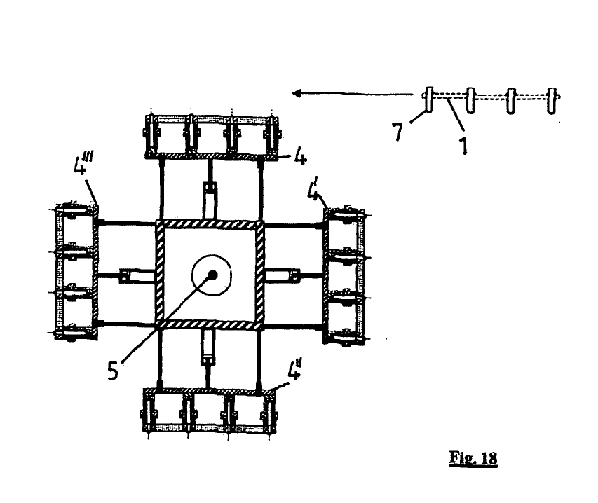

Finally FIG. 18 shows the entire post-treatment system. It will be seen that it has four post-treatment tools comprising pin plates 6, 6′, 6″, 6′″ and receiving plate 4, 4′, 4″, 4′″ which are fixed to a rotational unit rotatable about the shaft 5. The individual post-treatment tools can be fitted with preforms in succession by means of the rotational unit.

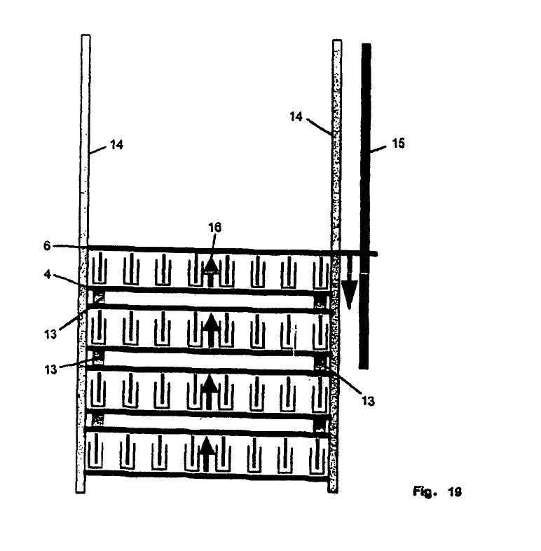

FIG. 19 diagrammatically shows a view from above of a fifth embodiment. Here the post-treatment system comprises a plurality of post-treatment tools (four are shown) which each have a pin plate 6 and a receiving plate 4. All post-treatment tools are arranged in mutually juxtaposed relationship, wherein a receiving plate 4 is always connected by way of connecting units 13 to a pin plate 6 of the adjacent post-treatment tool.

A post-treatment tool (in the illustrated example the uppermost post-treatment tool) is connected to a linear drive 15. By means of the linear drive the entire block of all post-treatment tools can be moved in one direction (in the illustrated example in the horizontal direction). The double-headed arrow shown in broken line is intended to denote the line of movement of a transfer device, by means of which the preforms are transferred from the injection molding mold into the post-treatment tools. As the preforms are to be transferred in succession into the respective post-treatment tools, the block of post-treatment tools can be displaced by means of the linear drive 15 in such a way that the post-treatment tool in question comes to lie directly in front of the line of movement of the transfer device. All post-treatment tools are carried on rails 14.

In addition each post-treatment tool has a stroke device 16, by means of which the respective post-treatment tool can be moved from the post-treatment position into the opened position.

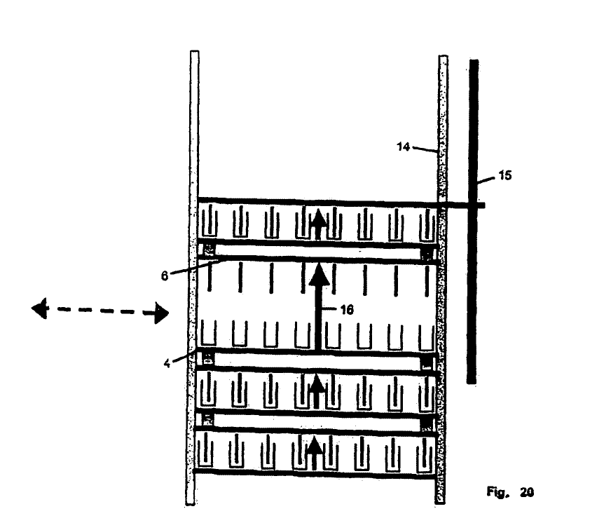

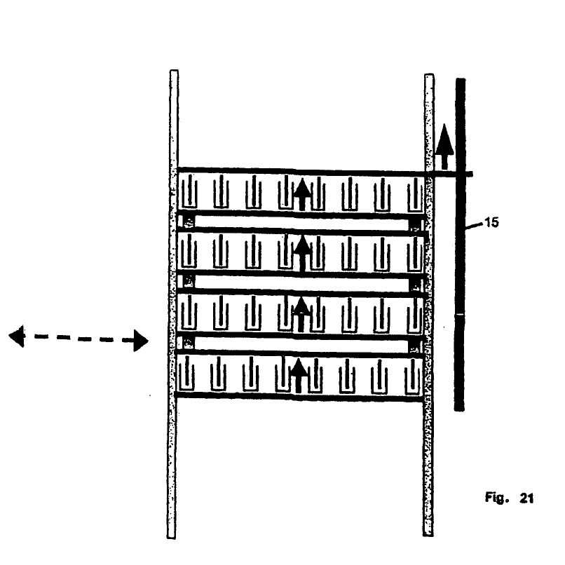

The sequence of movements is now described diagrammatically with reference to FIGS. 19 through 22. In FIG. 19 the block of post-treatment tools has been displaced by means of the linear drive in such a way that the line of movement of the transfer device comes to lie in front of the second post-treatment tool (the second from the top in the Figure). The second post-treatment tool can now be opened by means of the stroke device 16. That condition is shown in FIG. 20. Now any preform present in the post-treatment tool can be removed and a new set with preforms inserted. The post-treatment tool is then closed again and the block of post-treatment tools displaced by means of the linear drive in such a way that the line of movement of the transfer device now comes to lie in front of the third post-treatment tool (the second from bottom in the Figure). That situation is shown in FIG. 21.

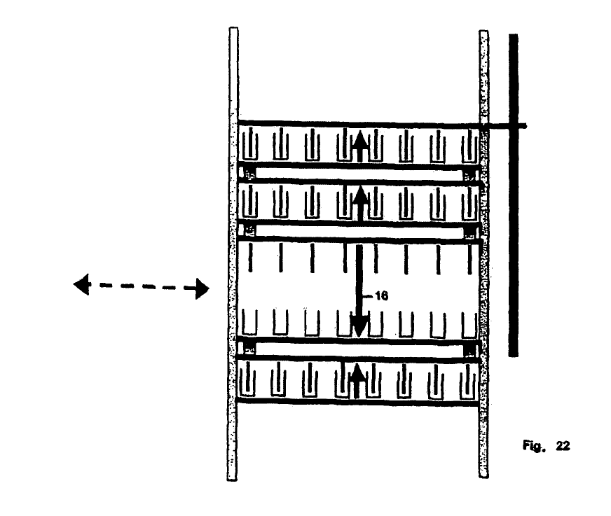

Finally FIG. 22 shows the situation which occurs after actuation of the corresponding stroke device 16 for opening the third post-treatment tool.

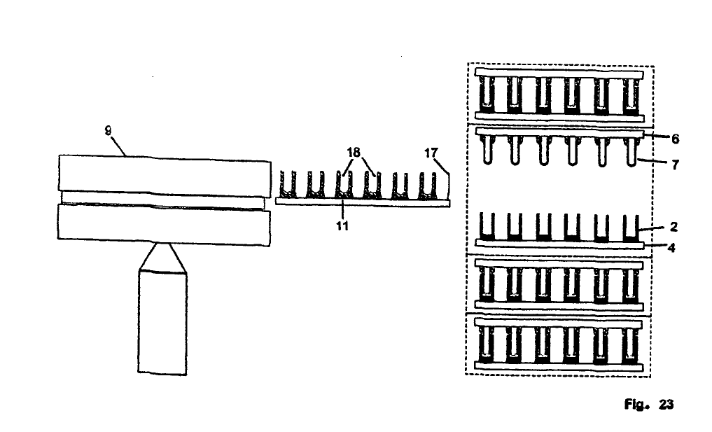

FIGS. 23 through 31 show a fifth embodiment. Here too this is a view from above, that is to say the injection molding tool is a horizontal tool in which the tool opens by horizontal relative movement of the tool portions with respect to each other.

FIG. 23 again shows a block comprising four post-treatment tools each with a cavity plate 4 and a pin plate 6. The second post-treatment tool II has just been opened and the preforms 7 (held for example by means of a vacuum device) are arranged at the pins 3 of the pin plate 6.

A gripper device 11 which here has a row of transfer cavities 18 and guide rails disposed therebetween can be moved both into the opened tool mold 9 and also into an opened post-treatment tool.

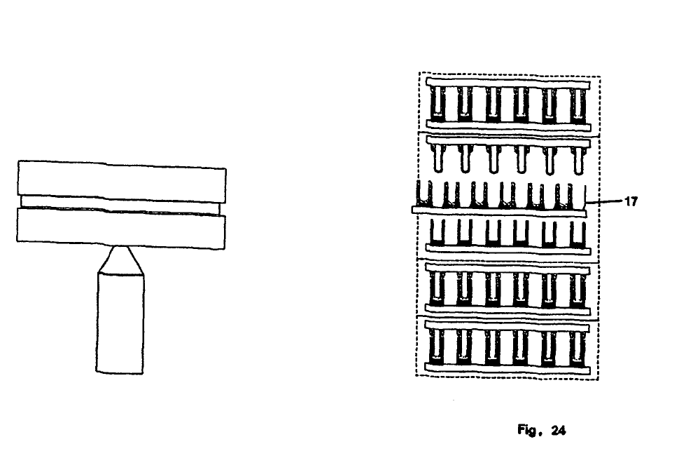

FIG. 24 shows a situation in which the gripper device 11 is within the opened post-treatment tool II. The gripper device 11 is so arranged that the guide rails 17 are arranged directly opposite the preforms 7 to be removed.

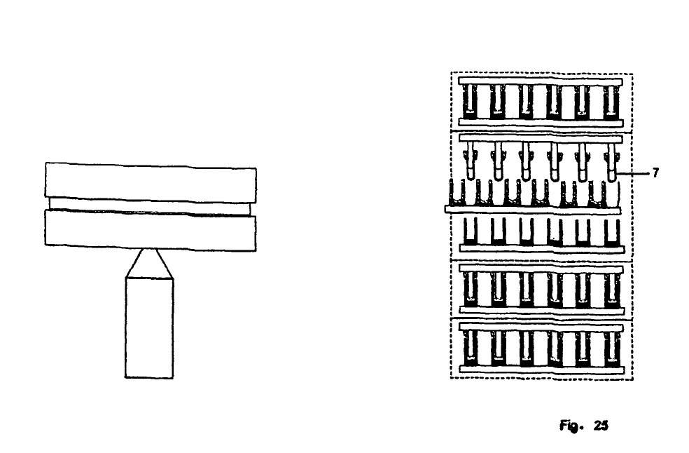

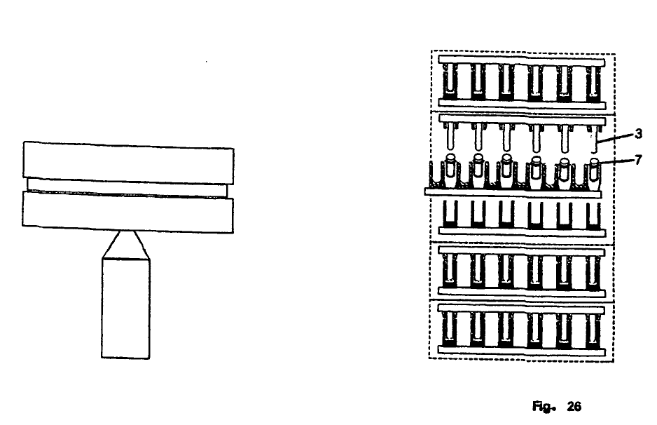

Now, as shown in FIGS. 25 and 26, the preforms 7 can be ejected from the pins for example by means of compressed air and fall along the guide rails 17. Optionally the guide rail can also be acted upon with compressed air to ensure speedy removal of the preforms 7 from the guide rails 17.

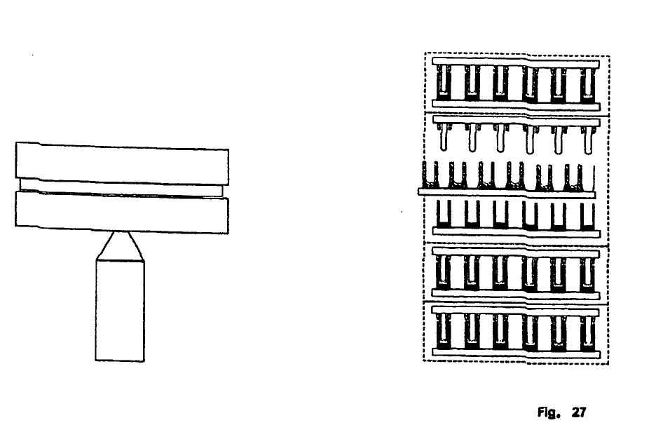

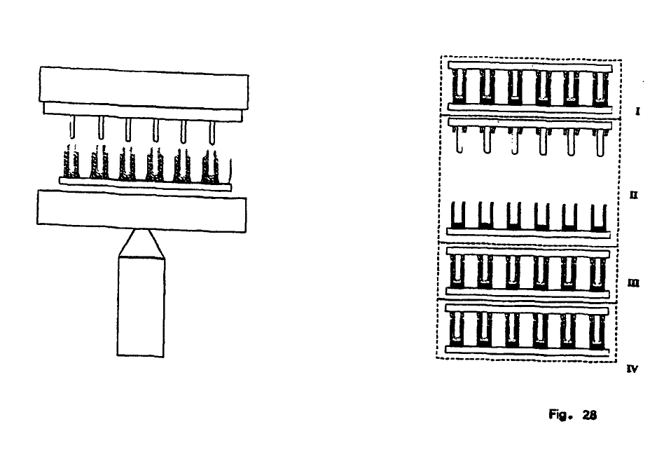

The gripper unit 11 is then moved out of the post-treatment tool and into the opened tool mold 9 so that a new group of preforms 7 can be transferred into the transfer cavities 18, as shown in FIGS. 27 and 28.

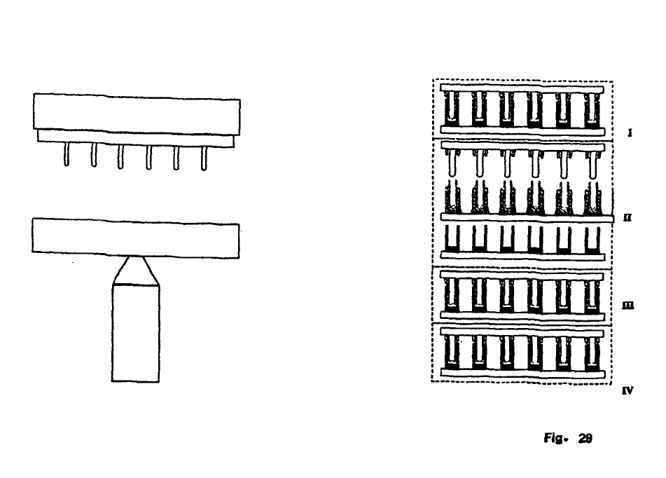

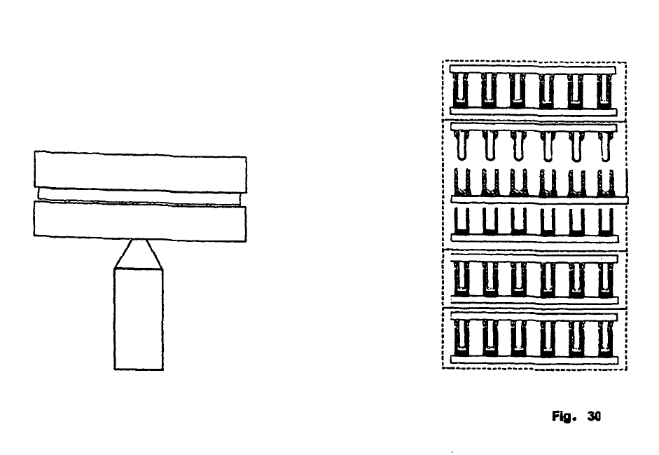

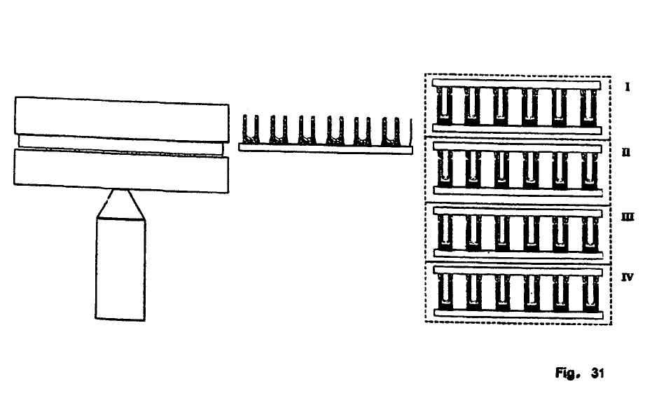

The gripper unit 11 then moves into the post-treatment tool again, in which case this time the transfer cavities 18 come to lie opposite the pins (FIG. 29). The preforms are transferred on to the pins (FIG. 30) and the gripper unit 11 moves out of the post-treatment tool so that the tool can close and post-treatment can begin in the post-treatment tool (FIG. 31).

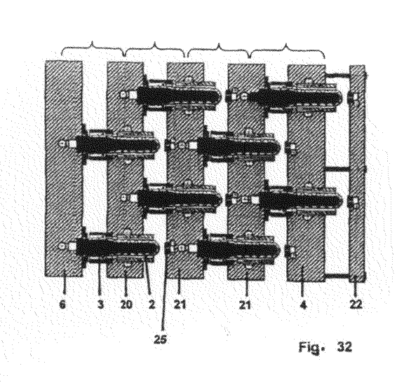

FIG. 32 shows a further embodiment of the system according to the invention. Shown here are a total of four post-treatment tools 19-1, 19-2, 19-3 and 19-4. Each post-treatment tool comprises a group of post-treatment pins 3 and a group of receiving cavities 2. The four post-treatment tools 19-1, 19-2, 19-3 and 19-4 are arranged in mutually juxtaposed relationship in FIG. 32. The first post-treatment tool 19-1 has a pin plate 6 carrying a group of post-treatment pins 3. In addition associated with the first post-treatment tool 19-1 is a plate 20 carrying a group of receiving cavities 2. The plate 20 additionally has a group of post-treatment pins 3. That group of post-treatment pins already belonged to the second post-treatment tool 19-2. The plate 20 is thus on the one hand part of the first post-treatment tool 19-1 as it makes the corresponding receiving cavities 2 available and on the other hand part of the second post-treatment tool 19-2 as it makes the corresponding post-treatment pins 3 available.

The plate 21 which adjoins at the right in FIG. 32 even has a triple function as, in addition to the receiving cavities 2 and the post-treatment pins 3, it also has a group of bottom nozzles 25. The receiving cavities have two open ends in the embodiment shown here. One serves for the feed of the preform 7 to be post-treated. As can be clearly seen from the Figure the inserted preform projects somewhat at the other end of the receiving cavity. Arranged opposite the bottom of the preform are bottom nozzles 25 through which a cooling fluid can be directed on to the bottom region of the preform 7. The bottom nozzles 25 of the central plate 21 thus form, together with the receiving cavity of the plate denoted by reference 20 and the post-treatment pin of the plate denoted by reference 6, the first post-treatment tool 19-1. The plate shown at the third location as viewed from the left in FIG. 31 thus provides bottom nozzles 25 for a first post-treatment tool 19-1, receiving cavities for a second post-treatment tool 19-2 and post-treatment pins for a third post-treatment tool 19-3.

To save space the post-treatment pins are always arranged between the receiving cavities of the same plates. The plate shown at the right-hand end in FIG. 32, denoted by reference 22, has only bottom nozzles 25.

Each of the four post-treatment tools 19-1, 19-2, 19-3 and 19-4 shown in the example serves to receive and post-treat a set of preforms while the injection molding tool is already producing the next set of preforms.

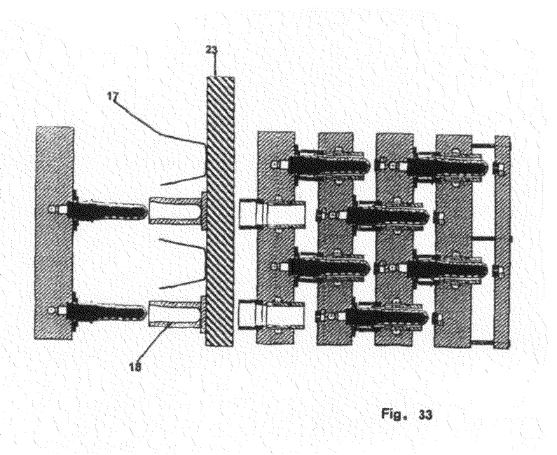

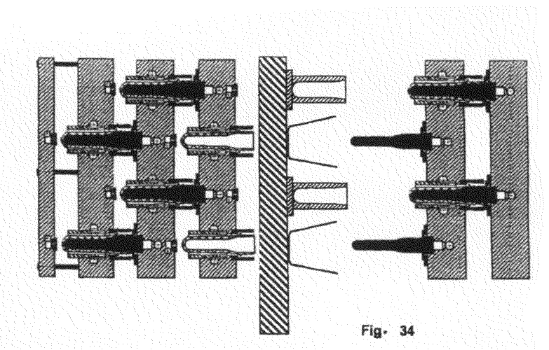

The function of the individual post-treatment tools or the alternate fitment and removal of the preforms is shown in FIGS. 33 and 34. The first post-treatment tool 19-1 can be opened by the plate with the post-treatment pins being moved relative to the plate with the receiving cavities. A situation in which the first post-treatment tool 19-1 is opened is shown in FIG. 33. Here a gripper plate 23 with corresponding gripper elements 18 and possibly with guide rails 17 can now be inserted into the open post-treatment tool 19-1. The gripper elements 18 serve to supply preforms while the guide rail 17 is used for removal of the preforms, as was already described in connection with the previous embodiments.

After the post-treated preforms have been removed from the first post-treatment tool and the new set of preforms has been pushed on to the post-treatment pin the first post-treatment tool 19-1 is closed and the second post-treatment tool 19-2 is opened. The gripper plate 23 is now moved into a position so that the guide elements 17 come to lie opposite the post-treatment pins 3. The preforms are removed and slide along the guide elements 17 out of the post-treatment tool. That situation is shown in FIG. 34.

All post-treatment tools can be successively fitted with preforms in the described fashion. When all post-treatment tools are fitted in that way, then, beginning with the first post-treatment tool, the post-treated preforms are removed and replaced by a fresh set of preforms.

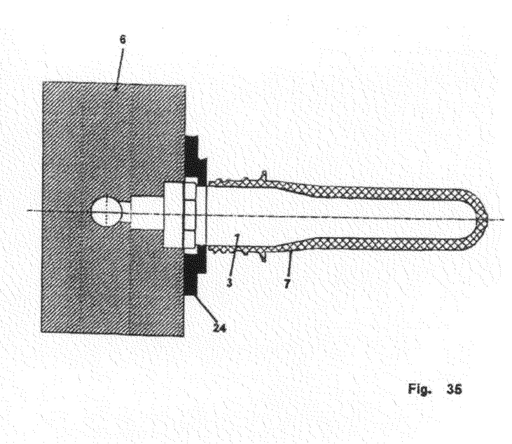

FIG. 35 shows by way of example a sectional view of a post-treatment pin 3 fixed to the pin plate 6. The post-treatment pin 3 is of an external contour approximately corresponding to the internal contour of the preform. The post-treatment pin 3 is screwed to the pin plate 6, the screw arrangement being covered by means of a cover element 24. It will be clearly seen that in the embodiment shown here the preform 7 does not touch the cover element 24 at the end.

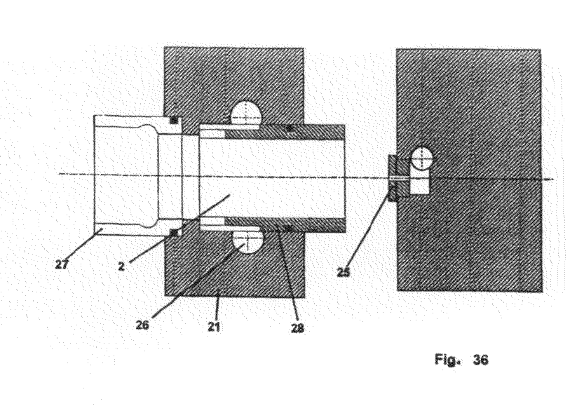

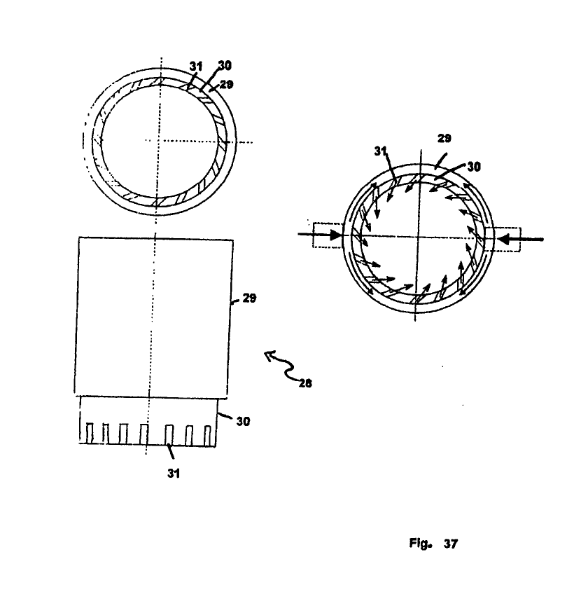

FIG. 36 shows a sectional view of a receiving cavity 2. The receiving cavity 2 is arranged in the receiving plate 21. For that purpose the receiving plate 21 has a through bore which has been enlarged at both ends by a respective bore of larger bore diameter. A head sleeve 27 is fitted into the through bore on one side. A casing sleeve 28 is inserted into the through bore on the other side. As can be better seen from FIG. 37 the casing sleeve 28 has a casing sleeve main portion 29 and a swirl element 30. The swirl element 30 is of a reduced outside diameter in relation to the casing sleeve main portion 29. The consequence of this is that, when the casing sleeve is fitted into the through bore in the receiving plate 21, an annular gap is formed in the region of the swirl element 30 between the swirl element 30 on the one hand and the receiving plate 21 on the other hand. It is precisely in that region that feed means for a cooling fluid 26 are provided in the receiving plate 21. Thus cooling fluid can be passed into the annular space by way of the feed means 26. The swirl element 30 has a row of slots 31 through which the cooling fluid can penetrate into the receiving cavity.

As can also be seen from FIG. 37 the slots 31 are angled with respect to the radial direction so that the cooling fluid is displaced in a circular motion by virtue of the swirl element 30, as is diagrammatically indicated by arrows in FIG. 37.

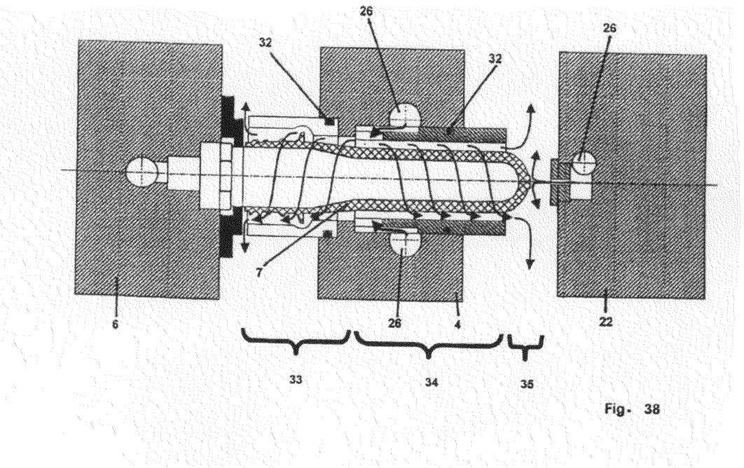

FIG. 36 additionally shows a bottom nozzle 25, by means of which a cooling fluid can be caused to act on the bottom region of the preform. The flow path of the cooling fluid is diagrammatically shown in FIG. 38. This Figure is a sectional view showing a portion of a closed post-treatment tool. The preform 7 sits on the post-treatment pin 3 which fits within the receiving cavity 2. The cooling fluid is fed through the cooling fluid feed means 26 on the one hand by way of the bottom nozzle 25 and on the other hand by way of the receiving plate 4. The preform substantially comprises three different portions which must be acted upon with cooling fluid to differing degrees in order to achieve optimum cooling. They are on the one hand the bottom region 35, furthermore the thick-walled body portion 34 and the thin-walled screwthread portion 33. The feed of cooling fluid for the bottom region 35 is controlled by means of the bottom nozzle 25. The thick-walled body portion 34 and the thin-walled screwthread portion 33 are supplied with cooling fluid by way of the cooling fluid feed means 26 of the receiving plate 4. That cooling fluid firstly passes into the annular space formed between the swirl element 30 on the one hand and the receiving plate 4 on the other hand. It there passes through the angular slots 31 into the receiving cavity, that is to say it passes through the casing sleeve 28. As the receiving cavity is open at both ends the cooling fluid flow is divided and passes in part out of the receiving cavity in the head region of the preform and for another part out of the receiving cavity in the bottom region. By virtue of the swirl element a circular movement is imparted to the cooling fluid so that it is guided in a kind of spiral motion around the preform. The proportion of the cooling fluid which issues at the head region and the portion which issues at the bottom region can be adjusted by virtue of a suitable configuration in respect of the flow resistance. The flow resistance is substantially determined by the size of the gap between the preform 7 on the one hand and the surrounding head sleeve 27 or casing sleeve 28 respectively on the other hand. The proportion of cooling fluid can thus be accurately adjusted by a suitable selection of the sleeves.

The invention may be broadly discussed with specific reference to item numbers in the drawings as examples as follows:

As previously discussed, in accordance with the invention, a system is provided for the post-treatment of preforms (7) produced in an injection molding mold. The system includes at least two post-treatment tools each of which have its own receiving plate (4) which has a group of receiving cavities (2) and its own pin plate (6) which has a group of post-treatment pins (3), and

a device for transferring the preforms (7) out of the injection molding mold alternately into the at least two post-treatment tools,

wherein the pin plate (6) and the receiving plate (4) of each post-treatment tool are reciprocatingly movable relative to each other between an open position in which the post-treatment pins (3) are arranged outside the receiving cavities (2) and a post-treatment position in which the post-treatment pins (3) are arranged at least partially in the receiving cavities (2).

The receiving plate may at the same time be in the form of a pin plate.

In the system, the transfer device may be a gripper plate (1) with gripper elements (11) for gripping the preforms (7) in the injection molding mold and transporting the preforms (7) alternately to the at least two post-treatment tools and the transfer device has an ejection system having ejection elements with which the preforms (7) can be released from the injection molding mold so that by virtue of the force of gravity they can be transferred alternately into the at least post-treatment tools.

In an open position the pin plate (6) and the receiving plate (4) may be reciprocatingly movable laterally relative to each other between the open position in which the pins are in opposite relationship to the receiving cavities (2) and a transfer position in which the pins and the receiving cavities (2) are not in opposite relationship.

A robot unit may be provided for moving each post-treatment tool into a readiness position from which the post-treatment tool can be moved to an open removal position for accepting preforms (7) or can be moved to an open ejecting position for ejecting of preforms (7). The robot unit may be so designed that each post-treatment tool can be moved into a waiting position. The robot unit may include a rotational unit which is rotatable about an axis of rotation, wherein the receiving plates (4) are fixed to the rotational unit so that they can be moved from the readiness position into the removal position by rotation of the rotational unit.

When in the removal position, the post-treatment tool may be moved into an open position wherein the receiving plate (4) and the pin plate (6) are laterally movable in the open position relative to each other to an ejection position where the preforms (7) can be ejected from the receiving plate (4).

In the ejection position the ends of the receiving cavities (2) may be so arranged that the preforms can be ejected from the receiving cavities (2) because of their own weight.

The transfer position may be arranged inside or outside of the injection molding mold.

The pin plate (6) may have through openings, through which the preforms (7) can be introduced into and/or ejected from the receiving cavities (2).

Further, the pin plate (6) may have gripper elements (8), wherein a gripper element is associated with each receiving cavity (2) of the associated receiving plate (4) and the pin plate (6) and the receiving plate (4) are movable relative to each other laterally between two positions and are movable towards and away from each other in both positions so that in the one position the post-treatment pins (3) can be introduced into the receiving cavities (2) and removed again and in the other position the preforms (7) can be removed from the receiving cavities (2) by means of the gripper elements (8).

A positioning device may be provided for positioning a first of the post-treatment tools in at least one positioning direction, wherein the at least two post-treatment tools are connected together so that, with the positioning device for positioning the first post-treatment tool, at least one further post-treatment tool can be positioned by corresponding positioning of the first post-treatment tool.

At least one opening and closing device is provided for moving the pin plate (6) and the receiving plate (4) between the open position and a post-treatment position wherein preforms (7) are treated. The positioning device and the opening and closing device are preferably oriented in a mutually co-linear relationship. The positioning device preferably includes a linear drive.

Desirably, at least two post-treatment tools are arranged in mutually juxtaposed relationship in the positioning direction, wherein the receiving plate of a post-treatment tool is connected to the pin plate of another post-treatment tool, e.g. at least two post-treatment tools are arranged displaceably on rails.

An opening and closing device is provided that is preferably a linear operating device. An opening and closing device may be provided for

A guide element is preferably provided for guiding a preform out of the post-treatment tool which guide element, when the post-treatment tool is opened, can be moved between the receiving plate and the pin plate of the post-treatment tool. The guide element can be a substantially U-shaped rail. The guide element may be provided on the device for transferring the preforms from the injection molding mold into the post-treatment tools. There may be only one opening and closing device functioning for all post treatment tools or opening and closing devices may be provided for each of them.

At least one locking device is preferably provided which in a locked position prevents opening of a corresponding post-treatment tool.

Preferably, the post-treatment tools are arranged in a row in mutually juxtaposed relationship in the positioning direction, the positioning device engages a first post-treatment tool of the row and the opening and closing device engages a last post-treatment tool of the row, so that by actuation of the positioning device the row of post-treatment tools can be positioned and by unlocking of the locking device for a post-treatment tool and locking of the locking device for all other post-treatment tools of the row and actuation of the opening and closing device, a post-treatment tool can be opened.

The post-treatment tools may be arranged in succession in the opening direction, wherein preferably the post-treatment pins and the receiving cavities of two adjacently arranged post-treatment tools are displaced relative to each other by approximately half the spacing of two adjacent receiving cavities of a receiving plate.

The at least two post-treatment tools each additionally may have a bottom plate with a group of bottom post-treatment devices and the receiving cavities are open on both sides. The bottom post-treatment devices may, for example, include a nozzle with which cooling fluid can be directed on to the bottom of the preform.

A single plate may at the same time be the bottom plate of a first post-treatment tool, the receiving plate of a second post-treatment tool and the pin plate of a third post-treatment tool.

The receiving plate desirably has a feed means for a cooling fluid, wherein the feed means for cooling fluid is so arranged that cooling fluid can be passed into each receiving cavity.

Further, the receiving cavities desirably have two open sides and the feed means for cooling fluid is so arranged that the cooling fluid is divided and leaves the receiving cavity at both open sides. The feed means for cooling fluid may have a swirl element which is so designed that it imparts a circular rotational movement to the cooling fluid.

The swirl element may for example include sleeve with a plurality of slots arranged in the longitudinal direction, wherein the slots are inclined relative to the radial direction in a sectional view perpendicularly to the sleeve axis.

The invention, as previously discussed further includes a method of post-treatment of a preform (7) produced in an injection molding mold, wherein the preform (7) is transferred out of the injection molding mold into a receiving cavity (2) whose internal shape substantially corresponds to the external shape of the preform (7), wherein a post-treatment pin (3) whose external shape substantially corresponds to the internal shape of the preform is introduced into the preform (7) and remains there for a period of time which is longer than the mold stand time of the injection molding mold.

The preform (7) is desirably prevented from coming into contact with the internal surface of the receiving cavity (2) by means of a fluid, e.g. a gas, which is introduced into the receiving cavity (2) through an opening in the receiving cavity (2). The fluid may be at least at times into the preform (7) through an opening in the post-treatment pin (3).

The fluid may also be introduced into the preform (7) in such a way that the preform (7) is pressed further into the receiving cavity (2) by the fluid as it flows out and substantially without direct contact between the post-treatment pin (3) and the preform (7).

In the method, as previously discussed, the receiving cavity may have two open ends and fluid is introduced into the receiving cavity in such a way that the fluid flows along the outside of the preform and issues from both ends of the receiving cavity.

### LIST OF REFERENCES

1 gripper plate
2 receiving cavity
3 post-treatment pin
4,4′,4″,4′″ receiving plate
5 shaft
6,6′,6″,6′″ pin plate
7 preform
8 opening
9 tool mold
10 drive
11 gripper elements
12 cores of the injection molding mold
13 connecting unit
14 rail
15 linear drive
16 stroke device
17 guide rail
18 transfer cavity
19-1-19-4 post-treatment tool
20 double-function plate
21 triple-function plate
22 bottom post-treatment plate
23 gripper plate
24 cover element
25 bottom nozzle
26 fluid feed means
27 head sleeve
28 casing sleeve
29 casing sleeve main portion
30 swirl element
31 slots
32 O-ring
33 thin-walled portion
34 thick-walled portion
35 bottom portion

What is claimed is:

1-41. (canceled)

42. A system for the post-treatment of preforms (7) produced in an injection molding mold, comprising at least two post-treatment tools each of which have its own receiving plate (4) which has a group of receiving cavities (2) and its own pin plate (6) which has a group of post-treatment pins (3), and a device for transferring the preforms (7) out of the injection molding mold alternately into the at least two post-treatment tools, wherein the pin plate (6) and the receiving plate (4) of each post-treatment tool are reciprocatingly movable relative to each other between an open position in which the post-treatment pins (3) are arranged outside the receiving cavities (2) and a post-treatment position in which the post-treatment pins (3) are arranged at least partially in the receiving cavities (2).

43. A system as set forth in claim 42 wherein the transfer device is a gripper plate (1) with gripper elements (11) for gripping the preforms (7) in the injection molding mold and transporting the preforms (7) alternately to the at least two post-treatment tools.

44. A system as set forth in claim 42 wherein the transfer device has an ejection system having ejection elements with which the preforms (7) can be released from the injection molding mold so that by virtue of the force of gravity they can be transferred alternately into the at least post-treatment tools.

45. A system as set forth in claim 42 wherein in an open position the pin plate (6) and the receiving plate (4) are reciprocatingly movable laterally relative to each other between the open position in which the pins are in opposite relationship to the receiving cavities (2) and a transfer position in which the pins and the receiving cavities (2) are not in opposite relationship.

46. A system as set forth in claim 42 wherein a robot unit is provided for moving each post-treatment tool into a readiness position from which the post-treatment tool can be moved to an open removal position for accepting preforms (7) or can be moved to an open ejecting position for ejecting of preforms (7).

47. A system as set forth in claim 46 wherein the robot unit is so designed that each post-treatment tool can be moved into a waiting position.

48. A system as set forth in claim 47 wherein the robot unit comprises a rotational unit which is rotatable about an axis of rotation, wherein the receiving plates (4) are fixed to the rotational unit so that they can be moved from the readiness position into the removal position by rotation of the rotational unit.

49. A system as set forth in claim 46 wherein in the removal position the post-treatment tool can be moved into an open position wherein the receiving plate (4) and the pin plate (6) are laterally movable in the open position relative to each other to an ejection position where the preforms (7) can be ejected from the receiving plate (4).

50. A system as set forth in claim 46 wherein in the ejection position the ends of the receiving cavities (2) are so arranged that the preforms can be ejected from the receiving cavities (2) because of their own weight.

51. A system as set forth in claim 45 wherein the transfer position is arranged outside the injection molding mold.

52. A system as set forth in claim 45 wherein the transfer position is arranged within the injection molding mold.

53. A system as set forth in claim 42 wherein the pin plate (6) has through openings, through which the preforms (7) can be introduced into and/or ejected from the receiving cavities (2).

54. A system as set forth in claim 42 wherein the pin plate (6) has gripper elements (8), wherein a gripper element is associated with each receiving cavity (2) of the associated receiving plate (4) and the pin plate (6) and the receiving plate (4) are movable relative to each other laterally between two positions and are movable towards and away from each other in both positions so that in the one position the post-treatment pins (3) can be introduced into the receiving cavities (2) and removed again and in the other position the preforms (7) can be removed from the receiving cavities (2) by means of the gripper elements (8).

55. A system as set forth in claim 42 wherein there is provided a positioning device for positioning a first of the post-treatment tools in at least one positioning direction, wherein the at least two post-treatment tools are connected together so that, with the positioning device for positioning the first post-treatment tool, at least one further post-treatment tool can be positioned by corresponding positioning of the first post-treatment tool.

56. A system as set forth in claim 55 wherein at least one opening and closing device is provided for moving the pin plate (6) and the receiving plate (4) between the open position and a post-treatment position wherein preforms (7) are treated.

57. A system as set forth in claim 56 wherein the positioning device and the opening and closing device are oriented in a mutually co-linear relationship.

58. A system as set forth in claim 55 wherein the at least two post-treatment tools are arranged in mutually juxtaposed relationship in the positioning direction, wherein the receiving plate of a post-treatment tool is connected to the pin plate of another post-treatment tool.

59. A system as set forth in claim 55 wherein the positioning device comprises a linear drive.

60. A system as set forth in claim 55 wherein the at least two post-treatment tools are arranged displaceably on rails.

61. A system as set forth in claim 56 wherein the opening and closing device is a linear device.

62. A system as set forth in claim 42 wherein a guide element is provided for guiding a preform out of the post-treatment tool which guide element, when the post-treatment tool is opened, can be moved between the receiving plate and the pin plate of the post-treatment tool.

63. A system as set forth in claim 62 wherein the guide element can be a substantially U-shaped rail.

64. A system as set forth in claim 62 wherein the guide element is provided on the device for transferring the preforms from the injection molding mold into the post-treatment tools.

65. A system as set forth in claim 56 wherein there is only one opening and closing device.

66. A system as set forth in claim 42 wherein at least one locking device is provided which in a locked position prevents opening of a corresponding post-treatment tool.

67. A system as set forth in claim 66 wherein the post-treatment tools are arranged in a row in mutually juxtaposed relationship in the positioning direction, the positioning device engages a first post-treatment tool of the row and the opening and closing device engages a last post-treatment tool of the row, so that by actuation of the positioning device the row of post-treatment tools can be positioned and by unlocking of the locking device for a post-treatment tool and locking of the locking device for all other post-treatment tools of the row and actuation of the opening and closing device, a post-treatment tool can be opened.

68. A system as set forth in claim 42 wherein at least one receiving plate is at the same time in the form of a pin plate.

69. A system as set forth in claim 68 wherein the post-treatment tools are arranged in succession in the opening direction, wherein preferably the post-treatment pins and the receiving cavities of two adjacently arranged post-treatment tools are displaced relative to each other by approximately half the spacing of two adjacent receiving cavities of a receiving plate.

70. A system as set forth in claim 42 wherein the at least two post-treatment tools each additionally have a bottom plate with a group of bottom post-treatment devices and the receiving cavities are open on both sides.

71. A system as set forth in claim 70 wherein the bottom post-treatment devices comprise a nozzle with which cooling fluid can be directed on to the bottom of the preform.

72. A system as set forth in claim 70 wherein at least one plate is at the same time the bottom plate of a first post-treatment tool, the receiving plate of a second post-treatment tool and the pin plate of a third post-treatment tool.

73. A system as set forth in claim 42 wherein the receiving plate has a feed means for a cooling fluid, wherein the feed means for cooling fluid is so arranged that cooling fluid can be passed into each receiving cavity.

74. A system as set forth in claim 73 wherein the receiving cavities have two open sides and the feed means for cooling fluid is so arranged that the cooling fluid is divided and leaves the receiving cavity at both open sides.

75. A system as set forth in claim 73 wherein the feed means for cooling fluid has a swirl element which is so designed that it imparts a circular rotational movement to the cooling fluid.

76. A system as set forth in claim 75 wherein the swirl element comprises a sleeve with a plurality of slots arranged in the longitudinal direction, wherein the slots are inclined relative to the radial direction in a sectional view perpendicularly to the sleeve axis.

77. A method of post-treatment of a preform (7) produced in an injection molding mold, wherein the preform (7) is transferred out of the injection molding mold into a receiving cavity (2) whose internal shape substantially corresponds to the external shape of the preform (7), wherein a post-treatment pin (3) whose external shape substantially corresponds to the internal shape of the preform is introduced into the preform (7) and remains there for a period of time which is longer than the mold stand time of the injection molding mold.

78. A method as set forth in claim 77 wherein the post-treatment pin (3) remains in the preform during a period of time which is at least twice as long as cycle time (10).

79. A method as set forth in claim 77 wherein the preform (7) is prevented from coming into contact with the internal surface of the receiving cavity (2) by means of a fluid which is introduced into the receiving cavity (2) through an opening in the receiving cavity (2).

80. A method as set forth in claim 77 wherein a fluid is introduced at least at times into the preform (7) through an opening in the post-treatment pin (3).

81. A method as set forth in claim 80 wherein the fluid is introduced into the preform (7) in such a way that the preform (7) is pressed further into the receiving cavity (2) by the fluid as it flows out and substantially without direct contact between the post-treatment pin (3) and the preform (7).

82. A method as set forth in claim 77 wherein a receiving cavity having two open ends is used and fluid is introduced into the receiving cavity in such a way that the fluid flows along the outside of the preform and issues from both ends of the receiving cavity.
